(19) United States
(12) Patent Application Publication
(10) Pub. No.: US 2011/0231251 A1
(43) Pub. Date: Sep. 22, 2011

(54) Digital broadcast network system for providing widget service and operating method thereof

(75) Inventors: Ho Yeon Jang, Namyangju-si (KR); Ju Young Yun, Seoul (KR)

(73) Assignee: TVSTORM CO., Ltd.

(21) Appl. No.: 12/662,947

(22) Filed: May 13, 2010

(30) Foreign Application Priority Data
Mar. 18, 2010 (KR) 10-2010-0024117

(51) Int. Cl. G06Q 30/00; H04N 7/025; G06Q 20/00

(52) U.S. Cl. 705/14.49; 705/14.4; 725/32

(57) ABSTRACT

Provided are a digital broadcast network system for providing a widget service and an operating method thereof The digital broadcast network system includes a communication network, a broadcast terminal, and a broadcasting station system. The broadcasting station system provides widget advertisement contents, received from a widget content provider, to the broadcast terminal. The broadcast terminal outputs the received widget advertisement contents to a display unit in response to a widget display control signal, and transmits product purchase information to the broadcasting station system when receiving a purchase request signal for products included in the widget advertisement contents.

### CROSS-REFERENCE TO RELATED APPLICATIONS

This U.S. non-provisional patent application claims priority under 35 U.S.C. §119 of Korean Patent Application No. 10-2010-0024111, filed on Mar. 18, 2010, the entire contents of which are hereby incorporated by reference.

### BACKGROUND OF THE INVENTION

The present invention disclosed herein relates to digital broadcast network systems.

Internet Protocol Television (IPTV) is an interactive TV service that is provided using an ultra high-speed Internet network. The IPTV provides information services, video contents and broadcasts to TV sets through the ultra high-speed Internet network. The IPTV may be regarded as a type of digital convergence in that it is a convergence of Internet and TV.

The IPTV is similar to cable broadcasting or satellite broadcasting in that it provides broadcast contents including video contents. However, the IPTV is characterized in that it further provides interactivity. Therefore, unlike public broadcasting, cable broadcasting or satellite broadcasting, the IPTV enables viewers to select and view desired programs at desired times.

Also, by using the ultra high-speed Internet network, the IPTV can provide not only an Internet search service but also various Internet-based contents and additional services, such as home shopping, home banking, on-line games and MP3 files, through TVs. However, such various services are still in an early stage of introduction. What is therefore required is a method for implementing a broadcasting station system capable of providing the various services.

### SUMMARY OF THE INVENTION

Embodiments of the present invention provide a digital broadcast network system for providing a widget service and an operating method thereof.

In some embodiments of the present invention, widget service operation methods of a digital broadcast network system including a broadcasting station system and a broadcast terminal include: receiving, by the broadcasting station system, widget advertisement contents from a widget content provider; transmitting the widget advertisement contents from the broadcasting station system through a communication network to the broadcast terminal; storing the widget advertisement contents, received from the broadcasting station system, in a memory by the broadcast terminal; outputting the widget advertisement contents, stored in the memory, to a display unit in response to a widget display control signal; and providing product purchase information from the broadcast terminal to the broadcasting station system when receiving a signal for purchase of products included in the widget advertisement contents.

In some embodiments, the broadcast terminal receives the widget display control signal and the product purchase signal from an input unit.

In other embodiments, the input unit includes at least one of a remote controller, a keyboard and a mouse.

In further embodiments, the providing of the product purchase information includes: transmitting a product purchase request from the broadcast terminal to the broadcasting station system when the broadcast terminal receives the product purchase signal from the input unit; providing an electronic payment service from the broadcasting station system to the broadcast terminal; and providing the product purchase information from the broadcast terminal to the broadcasting station system.

In still further embodiments, the widget service operation methods further include providing the product purchase information from the broadcasting station system to the widget content provider.

In still further embodiments, the widget service operation methods further include receiving a user authentication signal for the product purchase from the input unit by the broadcast terminal that has received the electronic payment service.

In still further embodiments, the widget advertisement contents are related to the current broadcast contents that are provided from the broadcasting station system through the communication network to the broadcast terminal.

In other embodiments of the present invention, digital broadcast network systems include: a communication network; a broadcast terminal; and a broadcasting station system providing widget advertisement contents, received from a widget content provider, to the broadcast terminal, wherein the broadcast terminal outputs the received widget advertisement contents to a display unit in response to a widget display control signal, and transmits product purchase information to the broadcasting station system when receiving a purchase request signal for products included in the widget advertisement contents.

In some embodiments, the digital broadcast network systems further include a remote controller communicating wirelessly with the broadcast terminal, wherein the broadcast terminal receives the widget display control signal and the purchase request signal from the remote controller.

In other embodiments, the broadcasting station system provides an electronic payment service to the broadcast terminal when receiving the purchase request signal form the broadcast terminal.

In further embodiments, the broadcast terminal provides product order information to the broadcasting station system when receiving a payment information signal from the remote controller.

In still further embodiments, the broadcasting station system provides the product order information to the widget content provider.

In still further embodiments, the widget advertisement contents are related to the current broadcast contents that are provided from the broadcasting station system through the communication network to the broadcast terminal.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating a structure of a digital broadcast network system for providing a widget service to a broadcast terminal according to an exemplary embodiment of the present invention;

FIG. 2 is a diagram illustrating that widget contents received from a broadcasting station system of FIG. 1 are displayed on a television;

FIG. 3 is a diagram illustrating a detailed structure of the broadcast terminal of FIG. 1;

FIG. 4 is a flow chart illustrating a widget service operation process of the broadcasting station system of FIG. 1;

FIG. 5 is a flow chart illustrating a widget service operation process of a broadcast terminal of FIG. 3;

FIG. 6 is a flow chart illustrating a widget service operation process of a widget content provider of FIG. 1;

FIG. 7 is a flow diagram illustrating a process of performing a widget service in the digital broadcast network system of FIG. 1; and

FIG. 8 is a diagram illustrating that widget contents are displayed on the television of FIG. 1.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Hereinafter, exemplary embodiments of the present invention will be described in detail with reference to the accompanying drawings.

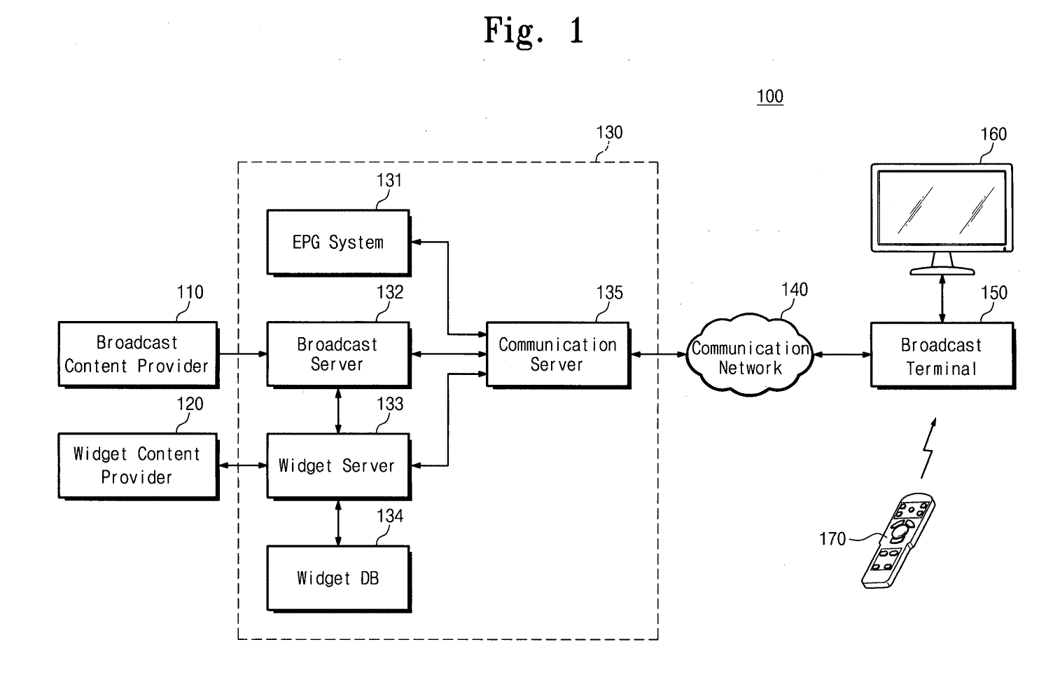

FIG. 1 is a diagram illustrating a structure of a digital broadcast network system 100 for providing a widget service to a broadcast terminal according to an exemplary embodiment of the present invention.

Referring to FIG. 1, the digital broadcast network system 100 includes a broadcasting station system 130, a communication network 140, and a broadcast terminal 150. The broadcasting station system 130 may receive broadcast contents and widget contents from a broadcast content provider 110 and a widget content provider 120. The broadcast terminal 150 is connected through the communication network 140 to the broadcasting station system 130. The broadcasting station system 130 is connected through the communication network 140 to the broadcast terminal 150. A television (TV) 160 may be connected to the broadcast terminal 150. The broadcast terminal 150 may receive wireless signals from a remote controller 170. The broadcast terminal 150 may receive wired or wireless signals not only from the remote controller 170 but also from one or more of various input devices such as keyboards and mouse.

The communication network 140 may be one of various communication networks such as Hybrid Fiber Coaxial (HFC), Asymmetric Digital Subscriber Line (ADSL), Wireless Local Loop (WLL), Fiber To The Curb (FTTC), Fiber To The Office (FTTO), and Fiber To The Home (FTTH).

The broadcast terminal 150 may be a broadcast signal receiver called a settop box (STB). The broadcast terminal 150 converts digital broadcast signals, received from broadcasting stations, into signals displayable on an image display device such as the television 160. According to another exemplary embodiment, the broadcast terminal 150 and the television 160 may be integrated into a single device. There may be a plurality of broadcast terminals connected through the communication network 140 to the broadcasting station system 130.

The broadcast content provider 110 may be individuals or enterprises that provide broadcast contents such as terrestrial broadcasting, movies, audio broadcasting, and news broadcasting. The widget content provider 120 may be individuals or enterprises such as banks, public offices, advertisement companies, and shopping malls that provide widget contents for enabling clock information, weather information, stock information, memo note, map information, search, home banking, shopping, and advertisement services.

The broadcasting station system 130 transmits broadcast contents, received from the broadcast content provider 110, and widget contents, received from the widget content provider 120, through the communication network 140 to the broadcast terminal 150.

The broadcasting station system 130 includes an EPG system 131, a broadcast server 132, a widget server 133, a widget database (DB) 134, and a communication server 135. The EPG system 131 provides an electronic program guide (EPG) related to broadcasting. The EPG includes broadcast schedule information such as channel name, broadcast title, broadcast time, genre, and broadcast summary. The EPG may be provided to the EPG system 131 by a content provider (not illustrated) that is external to the broadcasting station system 130. The EPG system 131 provides the EPG to the communication server 135.

The broadcast server 132 processes broadcast contents, received from the broadcast content provider 110, and transmits the broadcast contents to the communication server 135. The broadcast server 132 may include a database (not illustrated) for storing broadcast contents that are received from the broadcast content provider 110.

The widget server 133 receives widget contents from the widget content provider 120 and stores the received widget contents in the widget database 134. The widget server 133 outputs a list of available widget contents and the widget contents to the communication server 135.

The widget contents received from the widget content provider 120 include widget information contents and widget advertisement contents. Examples of the widget information contents include clock information, weather information, memo note, calculator, news, stock information, traffic information, and program information. Examples of the widget advertisement contents include contents for IPTV-based electronic commerce (i.e., Television commerce (T-commerce)) such as shopping, home banking, ticketing, remote diagnosis/treatment, game, and education.

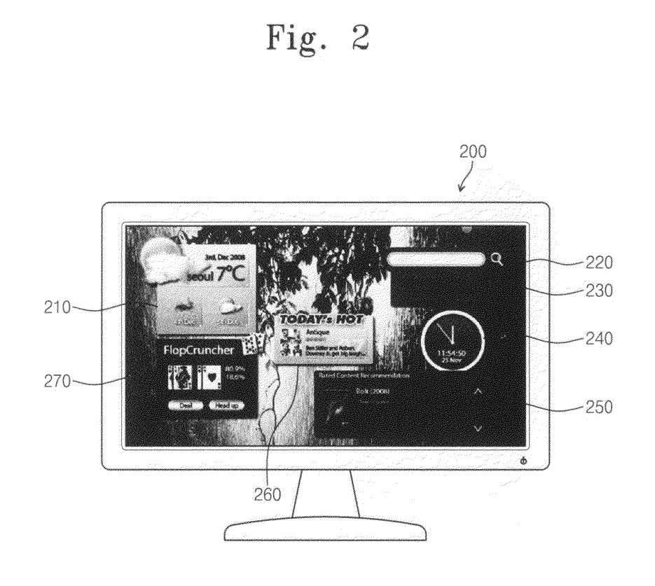

FIG. 2 is a diagram illustrating that widget contents received from the broadcasting station system 130 of FIG. 1 are displayed on a television 200.

Referring to FIG. 2, various widget contents 210 to 270 are displayed on a screen of the television 200. Examples of the widget contents displayed on the television 200 include date/weather information 210, search window 220, stock price 230, clock 240, movie guide 250, advertisement 260, and game 270. In this embodiment, the widget advertisement contents 260 may be widget contents for simple advertisement exposure or widget contents for shopping, home banking, ticketing, remote diagnosis/treatment, and game. The widget advertisement contents 260 may be displayed on the television 200 by user's selection or automatically in conjunction with broadcast contents. The user may purchase desired products while executing the widget advertisement contents 260 displayed on the television 200.

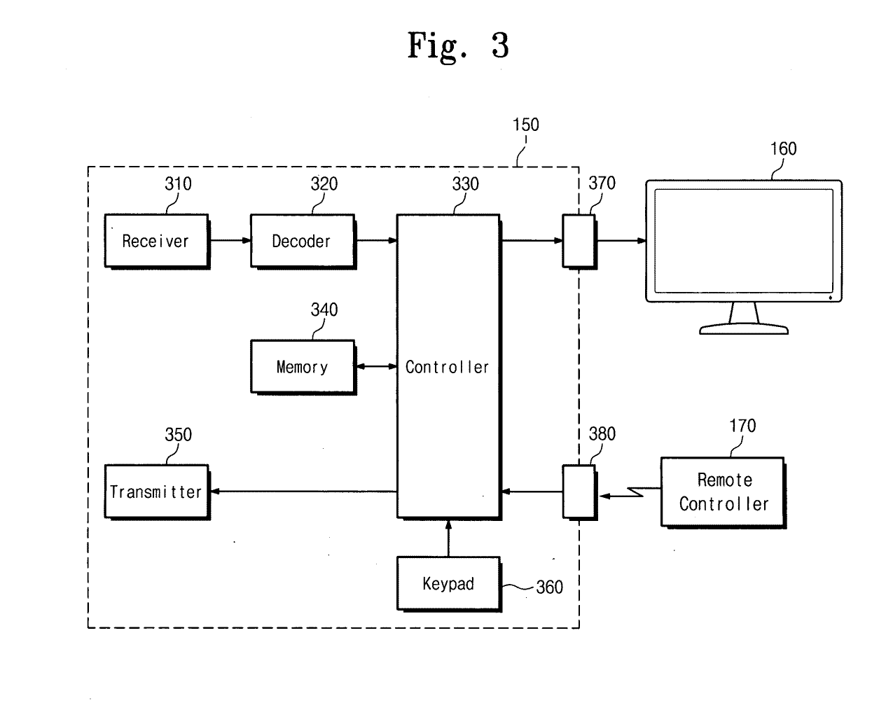

FIG. 3 is a diagram illustrating a detailed structure of the broadcast terminal 150 of FIG. 1.

Referring to FIGS. 1 and 3, the broadcast terminal 150 includes a receiver 310, a decoder 320, a controller 330, a memory 340, a transmitter 350, a keypad 360, a connector 370, and a signal converter 380.

The receiver 310 may include a tuner for receiving an external broadcast signal. The tuner tunes to receive a broadcast signal of a predetermined channel or a channel selected by the user. In order to minimize a signal distortion on a transmission path, a broadcaster, i.e., the broadcasting station system 130 of FIG. 1 encodes a broadcast signal in a predetermined scheme prior to transmission. The decoder 320 decodes the encoded broadcast signal into an original broadcast signal and divides a widget contents signal and a data signal included in the broadcast signal. The data signal may include information and application data that may be displayed in a graphic or text format on the television screen. In this embodiment, if the encoded broadcast signal includes a widget contents signal, the decoder 320 may divide the widget contents signal. The controller 330 processes the data signal, the widget contents signal and the broadcast signal received from the decoder 320, and outputs the resulting signals through the connector 370 to the television 160.

The memory 340 is used to store a program code for an operation of the controller 330, unique information of the broadcast terminal 150, widget contents, and a widget contents list that will be described later. In another example, the broadcast terminal 150 may include a memory for storing the program code for an operation of the controller 330 and another memory for storing the widget contents, the widget contents list and the unique information.

In order to minimize a signal distortion on a transmission path, the transmitter 350 encodes an output signal of the controller 330 in a predetermined scheme and transmits the resulting signal to the broadcasting station system 130 through the communication network 140 of FIG. 1. The keypad 360 includes a power button, channel selection buttons, volume control buttons, and function selection buttons. The controller 330 operates in response to a signal that is inputted from the keypad 360 by the user's control. The controller 330 may operate in response to a key input signal that is received from the remote controller 170 through the signal converter 380. For example, the remote controller 170 and the signal converter 380 perform infrared wireless communication. Although not illustrated in the drawings, the remote controller 170 may include a power button, channel number selection buttons, a widget display start button, menu change buttons, volume control buttons, and various function control buttons. When one of the buttons is pressed by the user, the remote controller 170 outputs a wireless signal corresponding to the pressed button. The signal converter 380 converts the wireless signal, received from the remote controller 170, into a digital signal and inputs the digital signal into the controller 330.

An operation of the broadcast terminal 150 with the above configuration will be described later in detail.

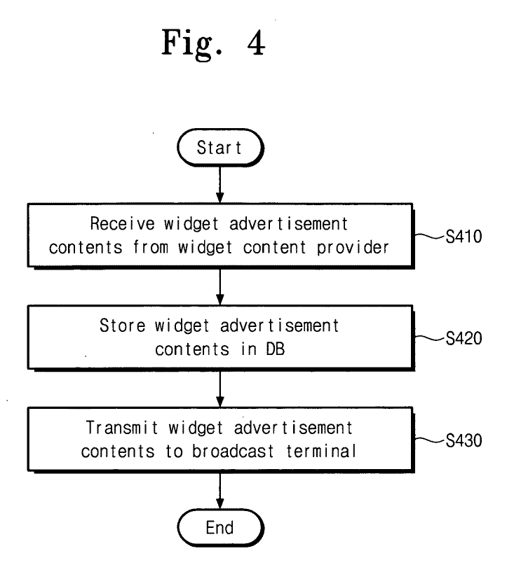

FIG. 4 is a flow chart illustrating a widget service operation process of the broadcasting station system 130 of FIG. 1.

Referring to FIGS. 1 and 4, the broadcasting station system 130 receives widget advertisement contents from the widget content provider 120 (S410). The widget advertisement contents may be widget contents for simple advertisement exposure (e.g., banners) or widget contents for shopping, home banking, ticketing, remote diagnosis/treatment, and game. The widget content provider 120 may provide the broadcasting station system 130 with widget advertisement contents related to broadcast contents provided by the broadcast content provider 110. For example, if the broadcast content provider 110 provides a drama to the broadcasting station system 130, the widget content provider 120 may provide widget advertisement contents for purchase of stage props used in the drama, widget advertisement contents for sale of travel products for drama shooting places, widget advertisement contents for advertisements of the drama shooting places, and widget advertisement contents for download purchase of other products of drama actors. In another exemplary embodiment, the broadcast contents and the widget advertisement contents may be provided by the same provider.

The broadcasting station system 130 stores the received widget advertisement contents in the widget database 134 (S420). The broadcasting station system 130 transmits the stored widget advertisement contents through the communication network 140 to the broadcast terminal 150 (S430). Herein, the widget server 133 of the broadcasting station system 130 controls the widget advertisement contents, which are related to the broadcast contents among the widget contents stored in the widget database 134, to be provided in conjunction with the broadcast contents provided by the broadcast server 132.

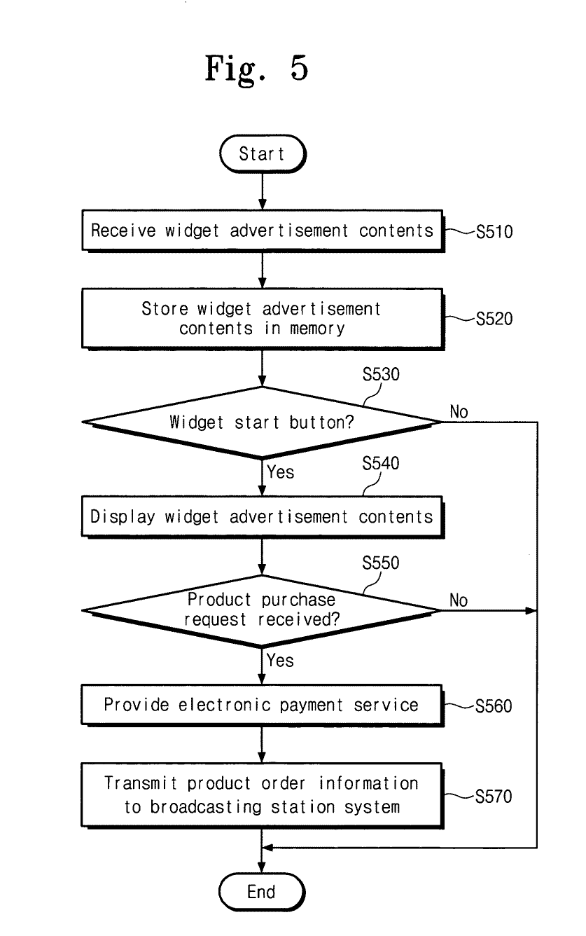

FIG. 5 is a flow chart illustrating a widget service operation process of the broadcast terminal 150 of FIG. 3.

Referring to FIGS. 1, 3 and 5, the receiver 310 of the broadcast terminal 150 receives widget advertisement contents through the communication network 140 from the broadcasting station system 130 (S510). The decoder 320 decodes an encoded broadcast signal into an original broadcast signal and divides a widget contents signal and a data signal included in the broadcast signal. The controller 330 stores the widget advertisement contents, received from the decoder 320, in the memory 340 (S520).

When the widget display start button of the remote controller 170 is pressed by the user, the controller 330 receives a signal, corresponding to the widget display start button, through the signal converter 380 from the remote controller 170. When receiving the signal corresponding to the widget display start button (S530), the controller 330 outputs the widget advertisement contents, stored in the memory 340, through the connector 370 to the television 160 (S540). When receiving a product purchase request signal from the remote controller 170 by the user's control (S550), the controller 330 performs control operations for providing the user with an electronic payment service for product purchase (S560). For example, the controller 330 receives user authentication information (e.g., user ID, secret number, i-PIN, or resident registration number) for electronic payment from the remote controller 170. The controller 330 transmits the product purchase request and user authentication information to the broadcasting station system 130 through the transmitter 350 and the communication network 140. The broadcasting station system 130 provides the broadcast terminal 150 with an electronic payment service such as an acknowledgement number for the user authentication information. When receiving a price payment signal from the remote controller 170 by the user's control, the broadcast terminal 150 transmits product order information to the broadcasting station system 130 (S570). The price payment may include various price payment means such as credit card, account transfer, point, mobile phone payment, and post-payment bill.

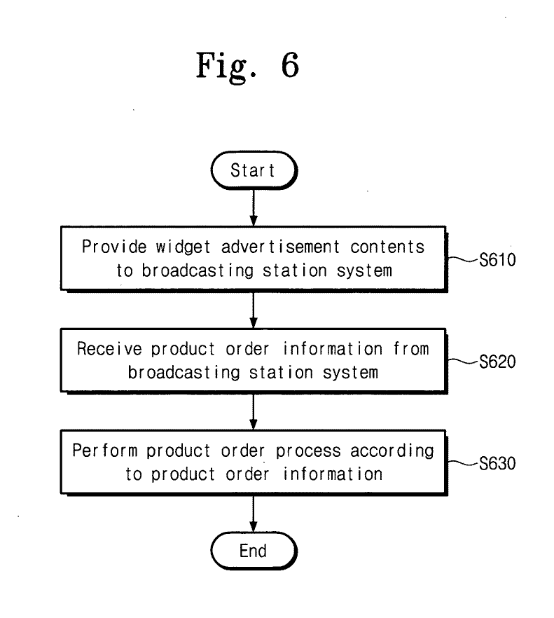

FIG. 6 is a flow chart illustrating a widget service operation process of the widget content provider 120 of FIG. 1.

Referring to FIGS. 1 and 6, the widget content provider 120 provides widget advertisement contents to the broadcasting station system 130 (S610). The widget content provider 120 receives product order information from the broadcasting station system 130 (S620). The widget content provider 120 performs a product order process according to the received product order information (S630). For example, if product delivery is necessary, the widget content provider 120 performs control operations for product package and product transfer to a delivery company according to the product order information. Also, the widget content provider 120 may provide the broadcasting station system 130 with a compensation for the product sale. In another example, the widget content provider 120 may provide the broadcasting station system 130 with a compensation according to the frequency of display of widget advertisement contents on the television 160.

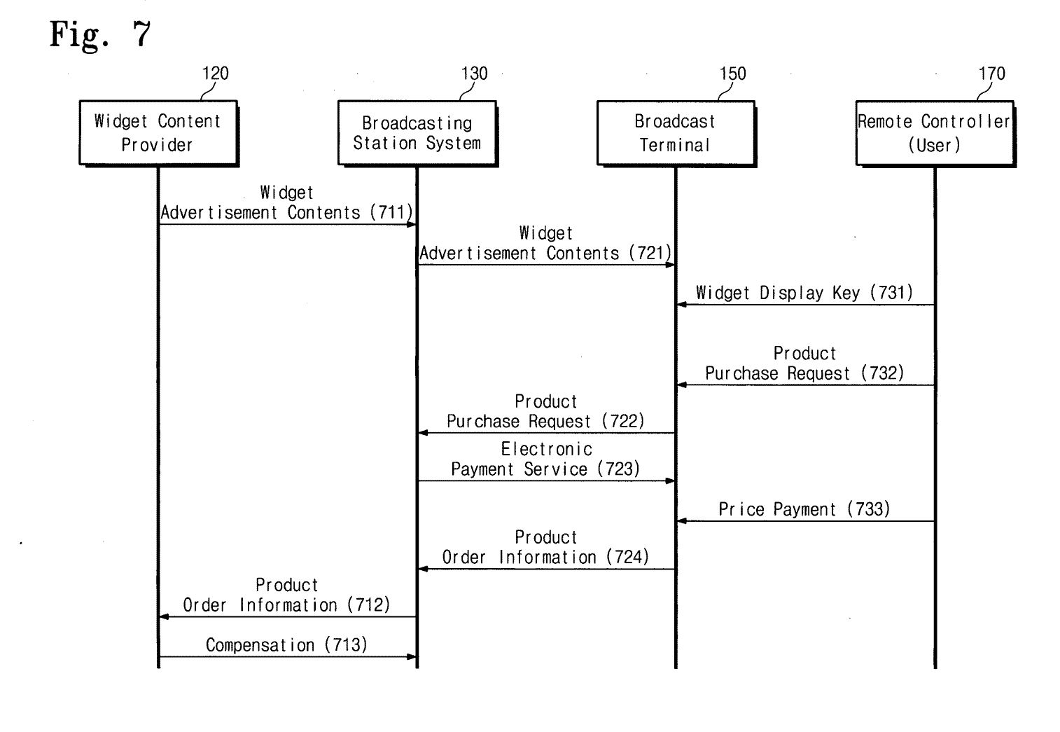

FIG. 7 is a flow diagram illustrating a process of performing a widget service in the digital broadcast network system 100 of FIG. 1.

Referring to FIGS. 1 and 7, the widget content provider 120 provides widget advertisement contents 711 to the broadcasting station system 130. The broadcasting station system 130 stores the received widget advertisement contents 711 in a memory and provides the broadcast terminal 150 with widget advertisement contents 721 stored in the memory. Herein, the widget advertisement contents 721 may be related to broadcast contents transmitted from the broadcasting station system 130 to the broadcast terminal 150.

The broadcast terminal 150 stores the widget advertisement contents, received from the broadcasting station system 130, in the memory. When receiving a signal 731 corresponding to a widget display key from the remote controller 170, the broadcast terminal 150 controls the stored widget advertisement contents to be displayed on the television 160. When receiving a signal 732 corresponding to a product purchase request from the remote controller 170, the broadcast terminal 170 transmits a product purchase request 722 to the broadcasting station system 130. The broadcasting station system 130 transmits an electronic payment service 723 to the broadcast terminal 150. The broadcast terminal 150 receives signals for price payment 733 from the remote controller 170. The broadcast terminal 150 provides the broadcasting station system 130 with product order information 724 such as purchaser's personal information, purchase product information, the number and amount of purchase products, and a delivery address. The broadcasting station system 130 provides product order information 712 to the widget content provider 120. The widget content provider 120 controls the purchase products to be delivered to the purchaser according to the purchase order information 712, and provides a compensation 713 to the broadcasting station system 130.

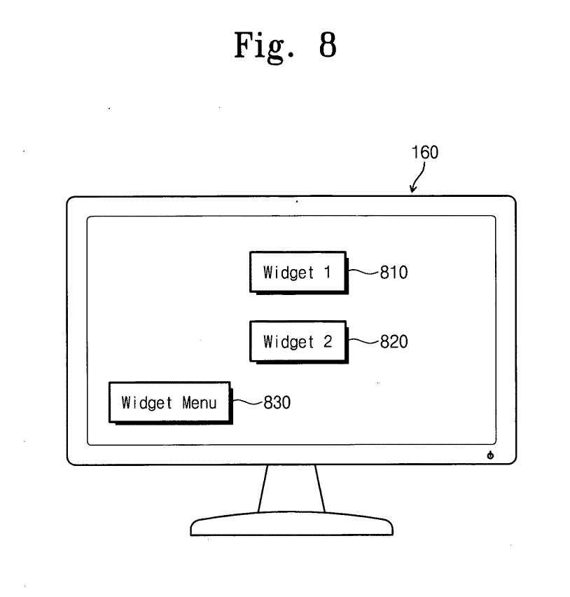

FIG. 8 is a diagram illustrating that widget contents are displayed on the television 160 of FIG. 1.

Referring to FIGS. 1, 3 and 8, the controller 330 may control a widget menu 830 to be displayed on the television 160 when widget contents 810 and 820 are displayed on the television 160. If a plurality of widget contents 810 and 820 and a widget menu 830 are displayed on the television 160, the user may use navigation buttons (e.g., up/down/left/right buttons) of the remote controller 170 to select the widget contents 810 and 820 and the widget menu 830 sequentially and alternately. While selecting the widget contents by the navigation buttons, the user may press the widget start button to change the display settings for the selected widget contents. For example, when the widget start button is pressed, the widget contents 810 and 820 and the widget menu 830 are simultaneously displayed on the television 160. At this point, a cursor (i.e., a location guide pointer for widget selection) is located at the widget menu 830, and the navigation buttons may be controlled to locate the cursor to change the widget contents 810 and 820 and the widget menu 830 alternately and sequentially.

When the cursor is located at the widget menu 830 and if the user presses the widget start button of the remote controller 170, the detailed menu items of the widget menu 802 are displayed on the television 160. The detailed menu items of the widget menu 830 may include new widget downloading and total widget display settings.

As described above, the use of the present invention makes it possible to implement a digital broadcast network system for providing a widget service. In particular, the broadcasting station system can provide users with widget advertisement contents related to broadcast contents, and can provide a product sale service through widget advertisement contents.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A widget service operation method of a digital broadcast network system including a broadcasting station system and a broadcast terminal, the widget service operation method comprising:
receiving, by the broadcasting station system, widget advertisement contents from a widget content provider;
transmitting the widget advertisement contents from the broadcasting station system through a communication network to the broadcast terminal;
storing the widget advertisement contents, received from the broadcasting station system, in a memory by the broadcast terminal;
outputting the widget advertisement contents, stored in the memory, to a display unit in response to a widget display control signal; and
providing product purchase information from the broadcast terminal to the broadcasting station system when receiving a signal for purchase of products included in the widget advertisement contents.

2. The widget service operation method of claim 1, wherein the broadcast terminal receives the widget display control signal and the product purchase signal from an input unit.

3. The widget service operation method of claim 2, wherein the input unit includes at least one of a remote controller, a keyboard and a mouse.

4. The widget service operation method of claim 2, wherein the providing of the product purchase information comprises:
transmitting a product purchase request from the broadcast terminal to the broadcasting station system when the broadcast terminal receives the product purchase signal from the input unit;
providing an electronic payment service from the broadcasting station system to the broadcast terminal; and
providing the product purchase information from the broadcast terminal to the broadcasting station system.

5. The widget service operation method of claim 4, further comprising providing the product purchase information from the broadcasting station system to the widget content provider.

6. The widget service operation method of claim 5, further comprising receiving a user authentication signal for the product purchase from the input unit by the broadcast terminal that has received the electronic payment service.

7. The widget service operation method of claim 1, wherein the widget advertisement contents are related to the current broadcast contents that are provided from the broadcasting station system through the communication network to the broadcast terminal.

8. A digital broadcast network system comprising:
a communication network;
a broadcast terminal; and
a broadcasting station system providing widget advertisement contents, received from a widget content provider, to the broadcast terminal,
wherein the broadcast terminal outputs the received widget advertisement contents to a display unit in response to a widget display control signal, and transmits product purchase information to the broadcasting station system when receiving a purchase request signal for products included in the widget advertisement contents.

9. The digital broadcast network system of claim 8, further comprising a remote controller communicating wirelessly with the broadcast terminal,
wherein the broadcast terminal receives the widget display control signal and the purchase request signal from the remote controller.

10. The digital broadcast network system of claim 9, wherein the broadcasting station system provides an electronic payment service to the broadcast terminal when receiving the purchase request signal form the broadcast terminal.

11. The digital broadcast network system of claim 10, wherein the broadcast terminal provides product order information to the broadcasting station system when receiving a payment information signal from the remote controller.

12. The digital broadcast network system of claim 11, wherein the broadcasting station system provides the product order information to the widget content provider.

13. The digital broadcast network system of claim 8, wherein the widget advertisement contents are related to the current broadcast contents that are provided from the broadcasting station system through the communication network to the broadcast terminal.
